(19) United States
(12) Patent Application Publication
(10) Pub. No.: US 2021/0400938 A1
(43) Pub. Date: Dec. 30, 2021

(54) Fishing Line Float Adapter and Assembly

(71) Applicant: Britt Moore, Augusta, KS (US)

(72) Inventor: Britt Moore, Augusta, KS (US)

(21) Appl. No.: 17/469,399

(22) Filed: Sep. 8, 2021

Related U.S. Application Data
(60) Provisional application No. 63/075,981, filed on Sep. 9, 2020.

(51) Int. Cl. A01K 93/00

(52) U.S. Cl. CPC A01K 93/00

(57) ABSTRACT

A fishing line float adapter incorporating a ring having a peripheral inner wall and an outer edge; a bottleneck receiving space defined by the peripheral inner wall; an arm having proximal and distal ends, the proximal end of the arm being fixedly attached to the ring's outer edge; and a fishing line engaging aperture extending through the distal end of the arm.

### CLAIM OF PRIORITY FROM PREVIOUSLY FILED PROVISIONAL PATENT APPLICATION

This non-provisional patent application claims the benefit of and priority from U.S. Provisional Patent Application No. 63/075,981 filed Sep. 9, 2020. The inventor disclosed in and applicant of said provisional application is the same person as the person who is disclosed as the inventor in and applicant of the instant application. The applicant asserts that structures and functions of structures disclosed and described in the instant application are substantially identical to those disclosed in said provisional application.

### FIELD OF THE INVENTION

This invention relates to fishing tackle floats and bobbers.

### BACKGROUND OF THE INVENTION

Large sized fishing bobbers or floats are commonly expensive, costing between $2.00 and $12.00. Such bobbers also are commonly bulky, taking up excess space within a fishing tackle box during storage.

The instant inventive fishing line float adapter and float assembly solves or ameliorates the above described problems of large sized fishing line floats and bobbers by providing a specialized flexible and elastic adapter which, in combination with a common plastic drink bottle, economically functions as a large sized fishing bobber which is compactly storable during periods of non-use.

### BRIEF SUMMARY OF THE INVENTION

A first structural component of the instant inventive adapter and assembly comprises a flexible and preferably elastic ring having a peripheral rim. Suitable plastics utilized in fabricating the ring component include medium density polyethylene, polypropylene, polyethylene terephthalate, silicone synthetic rubber, natural rubber, and phthalate softened polyvinyl-chloride. In a preferred embodiment, the elastic ring has an inside diameter which is fitted for receiving and annularly retaining the neck of a common plastic drink bottle.

A further structural component of the instant invention comprises a fishing line engaging aperture which preferably extends vertically through the rim of the ring component.

In use of the instant invention, an operator may procure a common disposable plastic drink bottle having a screw-on lid. Thereafter, the operator may extend the ring over the bottle's upper opening so that the bottle's neck is securely received and retained within the inner periphery of the ring. Suitably, the operator may partially fill the bottle with water. Thereafter, the operator may re-cap the bottle so that the cap, in addition to hermetically sealing the bottle, functions as an extraction stop against removal of the ring.

Thereafter, a fishing line may be extended through the aperture. Alternatively, a clip or snap latch attached to a fishing line or to a fishing line leader, may be engaged within and through the aperture. Upon such fishing line extension or engagement, the associated fishing line may be buoyantly supported by the bottle while suspending a baited fish hook within the body of water. During fishing use of the instant inventive assembly, the combination of the elastic ring, the capped bottle, and the attached line including a baited hook functions as a terminal fishing line assembly for bait fishing in a pond or lake.

In a preferred embodiment of the instant invention, a portion of the rim of the elastic ring is specially configured to form or present a cantilevering arm extension. In such embodiment, the cantilevering arm extension has a proximal end which is fixedly attached to or formed wholly with the periphery of the ring's rim, the fishing line engaging aperture component preferably being situated at and extending vertically through the distal end of such arm.

Also in the preferred embodiment, the aperture component is specially sized for receiving and retaining a fishing line sinker or weight. Where a sinker is incorporated as a component of the inventive assembly, the annular inner surface of the aperture may be specially sized and configured to allow the fishing line to be frictionally held by the sinker while the sinker performs its function of vertically orienting the bottle as it floats at the water's surface. Alternatively, a plug and tie combination may be molded integrally with the cantilevering extension arm, such plug being sized to provide the frictional holding of the fishing line within the aperture.

Where a provided sinker or an integrally molded plug is frictionally held within the fishing line receiving aperture, and where a fishing line extends between the wall of the plug or sinker and the aperture's wall, the interface between the aperture and the plug or sinker advantageously further frictionally holds the line at a selectively adjustable bait fishing depth. Upward and downward pulling forces which are manually applied to the fishing line may reposition the line within the aperture, effectively adjusting the depth at which a baited hook which is suspended below the bobber assembly.

Accordingly, objects of the instant invention include the provision of a fishing float adapter and bobber assembly which incorporate structures as described above, and which arranges those structures in relation to each in the manners described above for achievement of beneficial functions as described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of an adapter component of the instant invention.

FIG. 2 is a plan view of the structure of FIG. 1.

FIG. 3 is a sectional view as indicated in FIG. 2.

FIG. 4 includes a side view of the structure of FIGS. 1 and 2, the view further showing bottle, sinker, and fishing lines components of the invention.

FIG. 5 redepicts the structure of FIG. 4, the view of FIG. 5 showing the assembled invention floating during fishing use within a lake.

FIG. 6 presents an alternative configuration of the adapter of FIGS. 1-3.

FIG. 7 redepicts the structure of FIG. 6, the view of FIG. 7 showing an integrally molded plug component differently positioned.

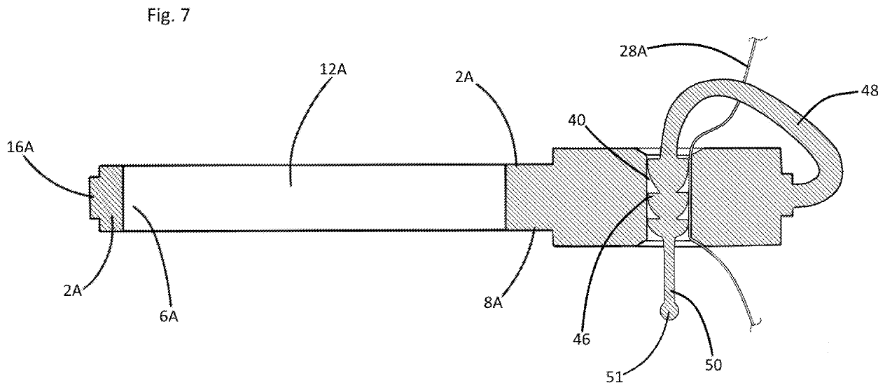

### DETAILED DESCRIPTION OF A PREFERRED EMBODIMENT

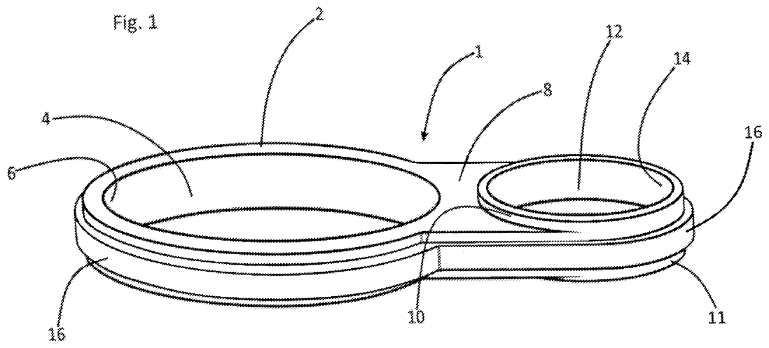

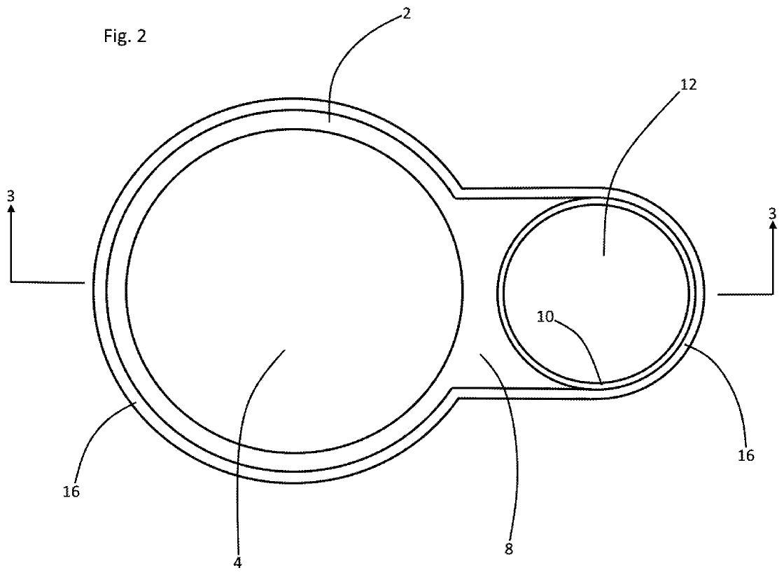

Referring now to the drawings and in particular to Drawing FIGS. 1-3, an adapter component of the instant invention is referred to generally by Reference Arrow 1. The adapter 1 comprises a circular ring 2 having a peripheral inner wall 6, such wall defining a circular bottleneck receiving space 4. A portion of the radially outer edge or rim of the ring 2 preferably forms a cantilevering arm 8, the proximal end of such arm being fixedly attached to or formed wholly with the ring 2. A fishing line engaging aperture 12, the function of which is further explained below, preferably extends vertically through the distal end of arm 8.

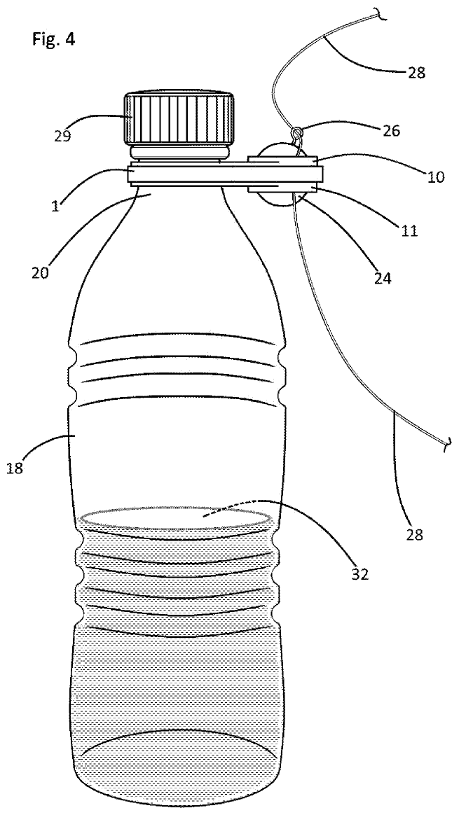

The peripheral inner wall 14 of the aperture 12 is suitably concave so that, referring further to FIG. 4, such wall's annular concavity may securely hold a fishing sinker 24 of the type having an arcuately curved wall. The depicted spherical configuration of sinker 24 is intended as being representative of other types of curved walled sinkers such as tear drop shaped sinkers and oval sinkers.

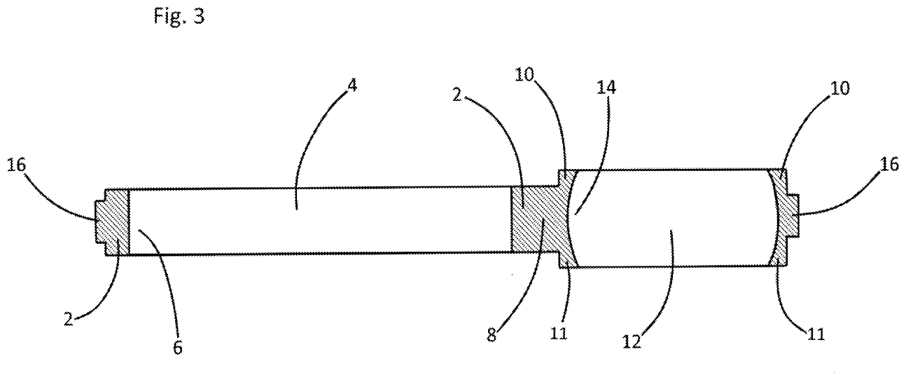

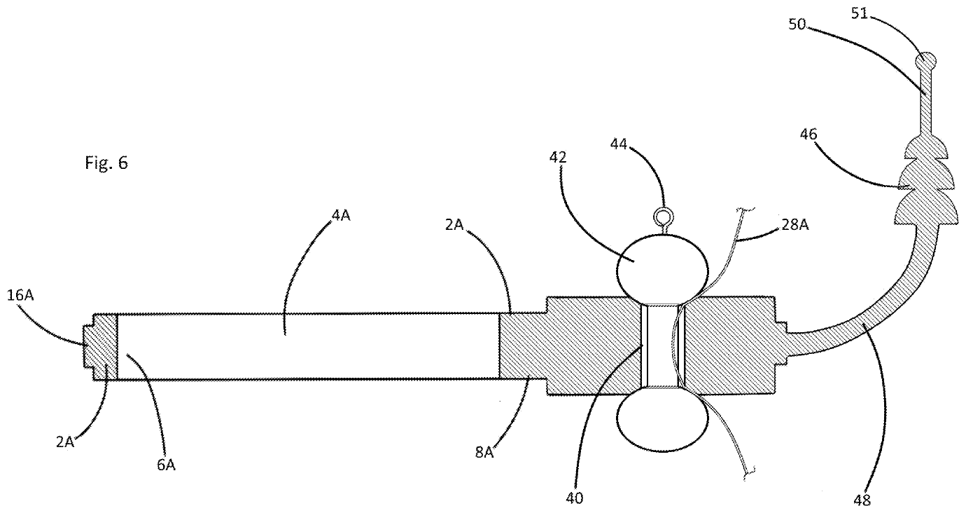

Alternatively, referring to FIG. 6, all structures appearing in FIG. 6 which are identified by a reference numeral having a suffix “A” are configured similarly with similarly numbered structures appearing in FIGS. 1-3. In the FIG. 6 structural alternative, a dumbbell shaped sinker 42 having a line engaging eye 44 is received within a line engaging aperture 40. In the FIG. 6 alternative, the enlarged upper and lower ends of the dumbbell shaped sinker 42 bear in the manner of extraction stops against the upper and lower rims or lips of aperture 40. Such bearing contacts of the dumbbell's ends provide sinker holding and retaining forces as a substitute for FIG. 3's concave wall 14.

The spherical sinker 24 of FIG. 4 and the dumbbell shaped sinker 42 of FIG. 6 are intended as being representative of various other sinker configurations and corresponding aperture configurations which may be incorporated into the distal end of arm 8 or 8A.

Upwardly and downwardly extending collars 10 and 11 may be provided at the periphery of aperture 12 (or aperture 40, as the case may be), such collars advantageously increasing the vertical dimension of the aperture for enhancement of holding forces applied to a received sinker and a co-extending fishing line. A reinforcing ridge 16 preferably extends peripherally about the ring 2 and the cantilevering arm 8.

In use of the adapter 1, referring to the structural alternative of FIGS. 1-4, a disposable plastic water bottle or drink bottle 18 may be provided, such provision constituting an ecological recycling use of the bottle. Thereafter, such bottle's screw-on cap 29 may be removed, and the adapter 1 may be flexibly stretched and extended over the bottle's upper opening or lip to reside at and about the bottle's neck 20 as indicated in FIG. 4. Thereafter, the bottle 18 may be partially filled with water 32, and the cap 29 may be screwed back into place in order to hermetically close the bottle 18. Upon such recapping, the cap 29 dually or additionally functions as an adapter retaining extraction stop. Thereafter, a curved walled fishing weight or sinker 24 and fishing line 28 may be provided, such weight 24 having an imbedded line engaging eye 26.

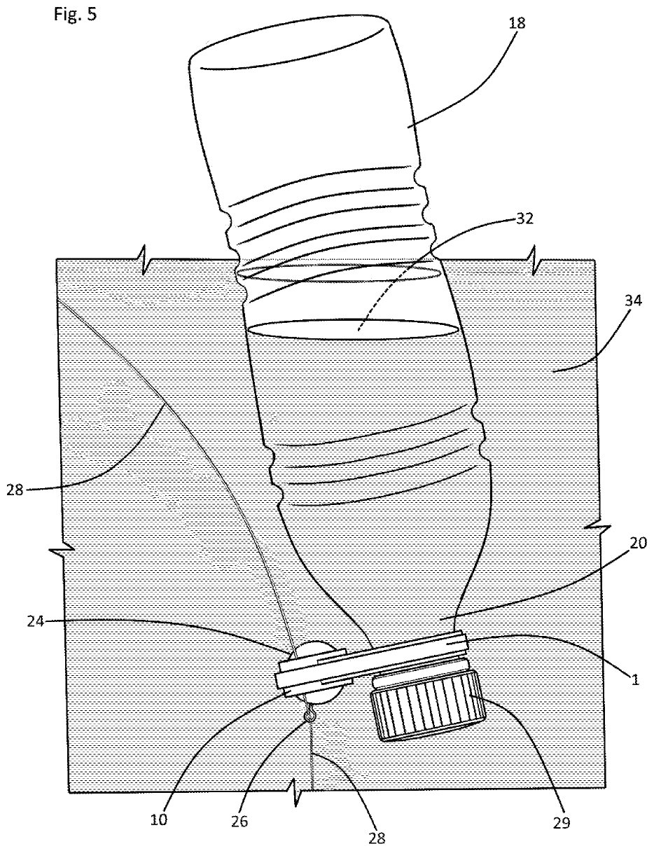

Thereafter, fishing line 28 may be extended both through the sinker's line receiving eye 26 and through the aperture 12. Thereafter, the sinker 24 may be pressed downwardly into aperture 12. In such assembly and configuration, elastic pressure applied by the concave wall 14 of aperture 12 against the sinker 24 and against that portion of fishing line 28 which vertically traverses the aperture 14 beneficially securely holds the fishing line in place. Referring further to FIG. 5, the assembly of FIG. 4 may then be cast into a lake or stream 34. In such configuration, the assembled adaptor 1, sinker 24, and bottle 18 advantageously function as a bait fishing bobber. During such usage, the weight of the sinker 24 holds the bottle within the water 34 in a substantially vertical orientation. Manually applied upward or downward pulling forces applied to the line 28 may draw the line 28 through the frictional line holding interface of the aperture 12 and the sinker 24. Accordingly, the adapter's holding actions against the line 28 and the sinker 24 advantageously allow the sinker plugged aperture 12 to function as means for adjusting the depth to which a baited hook is buoyantly suspended beneath the inventive assembly.

In the FIG. 6 structural alternative, the provision of a sinker may be suitably omitted. In such alternative configuration, a specially sized and annularly ridged plastic “Christmas tree” shaped plug 46 may be provided as an alternative means for frictionally holding the fishing line 28A within aperture 40. The depicted Christmas tree shape of plug 46 is intended as being representative of other differently configured plugs and correspondingly configured apertures which are capable of frictionally holding a fishing line. In order to prevent separation and loss of the plug 46, the adapter is suitably molded to integrally include a plastic tether 48 which extends from arm 8A to the relatively wide base end of the plug 46. A pull tab 50 may be further integrally molded to assist with manual installation of plug 46 within aperture 40. The pull tab 50 preferably extends from the relatively narrow opposite end of the plug 46, and the end of such tab is preferably configured as an enlarged knob 51 for assisting with manual grasping and pulling of the tab.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A fishing line float adapter comprising:
(a) a ring having a peripheral inner wall and having an outer edge;
(b) a bottleneck receiving space, said space being defined by said peripheral inner wall;
(c) an arm extending from the ring, the arm having a proximal end and a distal end, the proximal end of the arm being fixedly attached to or formed wholly with the ring's outer edge; and
(d) a fishing line engaging aperture positioned at the arm.

2. The fishing line float adapter of claim 1 wherein the bottleneck receiving space and the fishing line engaging aperture extends vertically, and wherein the fishing line engaging arm is further positioned at the distal end of the arm.

3. The fishing line float adapter of claim 2 wherein the arm's extension from the ring comprises a cantilevering extension.

4. The fishing line float adapter of claim 3 wherein the ring and the arm are composed of a material selected from the group consisting of polyethylene plastics, polypropylene plastics, polyethylene terephthalate, polyvinyl-chloride plastics, synthetic rubbers, and natural rubber.

5. The fishing line float adapter of claim 4 wherein the peripheral inner wall is concave.

6. The fishing line float adapter of claim 4 further comprising at least a first collar, said collar being fixedly attached to or formed wholly with the arm, said collar extending upwardly from or downwardly from a periphery of the fishing line engaging aperture.

7. The fishing line float adapter of claim 6 further comprising a second collar, said collar being fixedly attached to or formed wholly with the arm, said collar extending away from the at least first collar.

8. The fishing line float adapter of claim 4 further comprising a ridge extending about the ring's outer edge.

9. The fishing line float adapter of claim 8 wherein the arm has an outer edge, and wherein the reinforcing ridge further extends about the arm's outer edge.

10. The fishing line float adapter of claim 3 further comprising a fishing line holding plug, said plug being fitted for insertion into the fishing line engaging aperture.

11. The fishing line float adapter of claim 10 further comprising a tether having an end fixedly attached to or formed wholly with the fishing line holding plug.

12. The fishing line float adapter of claim 11 wherein the tether has an opposite end fixedly attached to or formed wholly with the arm.

13. The fishing line float adapter of claim 11 wherein the end of the tether which is fixedly attached to or formed wholly with the fishing line holding plug is positioned at a base end of said plug.

14. The fishing line float adapter of claim 13 wherein the tether has an opposite end, said end being fixedly attached to or formed wholly with the arm.

15. The fishing line float adapter of claim 14 wherein the fishing line holding plug has an end opposite its base end, said plug opposite end being narrow with respect to said plug base end.

16. The fishing line float adapter of claim 15 wherein the plug is Christmas tree shaped.

17. The fishing line float adapter of claim 16 further comprising a pull tab fixedly attached to or formed wholly with the end of the fishing line holding plug which is opposite said plug's base end.

18. The fishing line float adapter of claim 17 further comprising a knob fixedly attached to or formed wholly with an end of the plug tab.
